(19) United States
(12) Patent Application Publication
(10) Pub. No.: US 2004/0101238 A1
(43) Pub. Date: May 27, 2004

(54) Fiber optic coupling system and method for improved alignment tolerances

(76) Inventor: Christopher L. Coleman, Santa Clara, CA (US)

Correspondence Address: AGILENT TECHNOLOGIES, INC., Intellectual Property Administration, Legal Department, DL429, P.O. Box 7599, Loveland, CO, 80537-0599, US

(21) Appl. No.: 10/301,988

(22) Filed: Nov. 22, 2002

(51) Int. Cl. G02B 6/32

(52) U.S. Cl. 385/33

(57) ABSTRACT

An optical signal coupling system including an optical source, beam shaping lens system, and a waveguide is disclosed. The beam shaping lens system converges the optical signal from the optical source into a focal area that is larger than the cross sectional area of the waveguide. The converged optical signal has a predetermined power distribution profile at the focal area such as a uniform distribution. Accordingly, misalignments of the waveguide and the optical signal source have minimal impact on the coupling efficiency of the optical signal from the optical source to the waveguide.

### BACKGROUND

The present invention relates to optical signal coupling technology, and more particularly, to a method and apparatus for efficiently coupling optical signal from an optical source to an optical receiver.

Optical communication technology is becoming a de facto foundation on which the global communication infrastructure is based. This is because optical communication systems are able to carry large amounts of information at high speeds over long distances with resistance to electromagnetic interferences. Optical communication systems require a variety of devices that work with optical signals. For example, lasers and light emitting diodes (LEDs) are used to generate optical signals and waveguides, such as optical fiber, are used to transmit the generated light to various parts of the optical communication system. Coupling efficiency of the optical signals between the optical devices play an important role in efficient transfer of optical signals within the communication systems. In particular, direction and alignment of various optical devices at coupling junctions is critical in efficient transfer of optical signal power from one device to another. The coupling alignment is especially critical when dealing with single mode optical fibers since these fibers have a small diameter (on the order of 9 microns) and have a relatively narrow acceptance angle within which light is accepted.

Optical signal such as laser radiation is commonly coupled into a waveguide such as single mode optical fiber by one of two means—butt-coupling or imaging with a lens. FIG. 1 illustrates a butt coupling system where optical signal (represented by vectors 11) from an optical source, for example a laser 10, is coupled to a waveguide such as an optical fiber 12. Here, the optical fiber 12 is positioned in the path of the optical signal 11 to capture the optical signal 11 via its capture end 14.

The optical signal 11 diverges, as illustrated, when it leaves the laser 10. As it diverges, the optical signal 11 forms a generally elliptical area 13 on a capture plane 15 at which the capture end 14 of the optical fiber 12 captures the optical signal 11. The capture plane 15 is normal to the central axis of optical signal 11. The capture plane 15 is illustrated having two orthogonal axes 19. For convenience, the orthogonal axis 19 on the capture plane 15 is referred to as the X-Y axis 19, and the central axis of optical signal 11 is referred to as the Z-axis 29; the Z-axis 29 being orthogonal, or normal, to the capture plane 15. The power of the optical signal 11 is not uniform over the elliptical area 13. Rather, the power of the optical signal 11 typically has a Gaussian-like distribution as illustrated by a Gaussian-like curve 17 with relatively more power at the center. As illustrated, the power level decreases away from the center. A single mode optical fiber 12, in current technology, has a generally cylindrical core with a circular cross-section with a diameter ranging from nine to ten micrometers (microns).

In the butt coupling system, only a fraction of the power of the optical signal 11 is captured into the optical fiber 12. This is due to the relatively large angle divergence of the optical signal 11, Gaussian distribution of the power of the optical signal 11, and the relatively small cross-section of the optical fiber 12. Further, for the same reasons, lateral misalignment (in the X-direction, the Y-direction, or both on the capture plane 15) of the optical fiber 12 from its ideal, central position of the Gaussian power curve 17 on the image plane 15 leads to large variation in the captured power.

FIG. 2 illustrates another common coupling system (a “lens coupling system”) including an imaging lens 20. Here, the imaging lens 20 focuses the optical signal 11, onto an imaging plane 21, to a focal area 23. The capture end 14 of the optical fiber 12 is positioned at the focal area 23 to capture the focused optical signal. In FIG. 2, only for clarity of illustration, the optical fiber 12 is shown proximal to but not at the focal area 23.

In the lens coupling system, coupling efficiency from the laser 10 to the optical fiber 12 is higher than the coupling efficiency of the butt coupling system. However, there remains the problem of the high sensitivity of the coupling efficiency to lateral misalignment (in the X-direction, the Y-direction, or both on the image plane 21) of the optical fiber 12 from the focal area 23. Further, the lens 20 can introduce additional misalignment errors leading to even larger variations in efficiency. Coupling efficiency is the ratio of the power of the captured, or received, signal by the optical fiber 12 to the power of the emitted optical signal 11.

FIG. 3 illustrates the sensitivity of the butt coupling system and the lens coupling system to the lateral misalignments. For the butt coupling system, butt coupling system efficiency curve 32 shows that the coupling efficiency varies from approximately −13 dB loss to approximately −17.5 dB loss for lateral misalignments ranging from zero to five microns. The butt coupling system efficiency curve 32 illustrates a butt coupling system implementation where the capture plane 15 is at the end of the laser 10. For the lens coupling system, lens coupling system efficiency curve 34 shows that the coupling efficiency varies from approximately −0.2 dB loss to approximately −5.6 dB loss for lateral misalignments ranging from zero to five microns.

For both the butt coupled and the lens coupled systems, to minimize the variation in coupling efficiency due to lateral misalignments, the systems must be fabricated within very tight alignment tolerances. High tolerances manufacturing is time-consuming and expensive. Further, even when fabricated to meet the tight alignment tolerances, power transfer efficiency can drift during operation of the coupling module due to misalignments caused or exacerbated by environmental factors such as temperature.

Consequently, there remains a need for a coupling system with reduced sensitivity to misalignments with an acceptable coupling efficiency.

### SUMMARY

The need is met by the present invention. According to a first aspect of the present invention, an apparatus includes an optical source adapted to provide optical signal and a beam shaping lens system adapted to converge the optical signal into a focal area at a focal plane, the converged optical signal having a predetermined power distribution profile at the focal area. A waveguide with a core adapted to receive the converged optical signal is placed within the focal area at the focal plane, the focal area defining an area greater than the cross sectional area of the core.

According to a second aspect of the present invention, an apparatus includes a laser adapted to provide optical signal and a diffractive optical element adapted to converge the optical signal into a circular focal area at a focal plane, the optical signal having a predetermined power distribution profile at the focal area. A waveguide fiber with core receives the converged optical signal, the focal area being larger than cross sectional area of the core of the waveguide.

According to a third aspect of the present invention, a method of coupling optical signal is disclosed. The optical signal is converged into a focal area at a focal plane, the converged optical signal having a predetermined power distribution profile at the focal area. Then, the converged optical signal is received into a waveguide, the focal area defining an area greater than the cross sectional area of the core.

Other aspects and advantages of the present invention will become apparent from the following detailed description, taken in combination with the accompanying drawings, illustrating by way of example the principles of the invention.

### BRIEF DESCRIPTION OF THE DRAWINGS

FIG. 1 illustrates a butt coupling system;

FIG. 2 illustrates a lens coupling system;

FIG. 3 illustrates optical signal power transfer efficiency curves;

FIG. 4 illustrates an optical signal coupling system according to one embodiment of the present invention;

FIG. 5A illustrates a portion of the optical signal coupling system of FIG. 4;

FIG. 5B illustrates a sample power distribution profile as applied to a portion of the optical signal coupling system of FIG. 4;

FIG. 6 illustrates an optical signal coupling system according to another embodiment of the present invention;

FIG. 7A illustrates a front view of one embodiment of a component of the optical signal coupling system of FIG. 6; and

FIG. 7B illustrates a cut-away side view of a portion of the component of FIG. 7a.

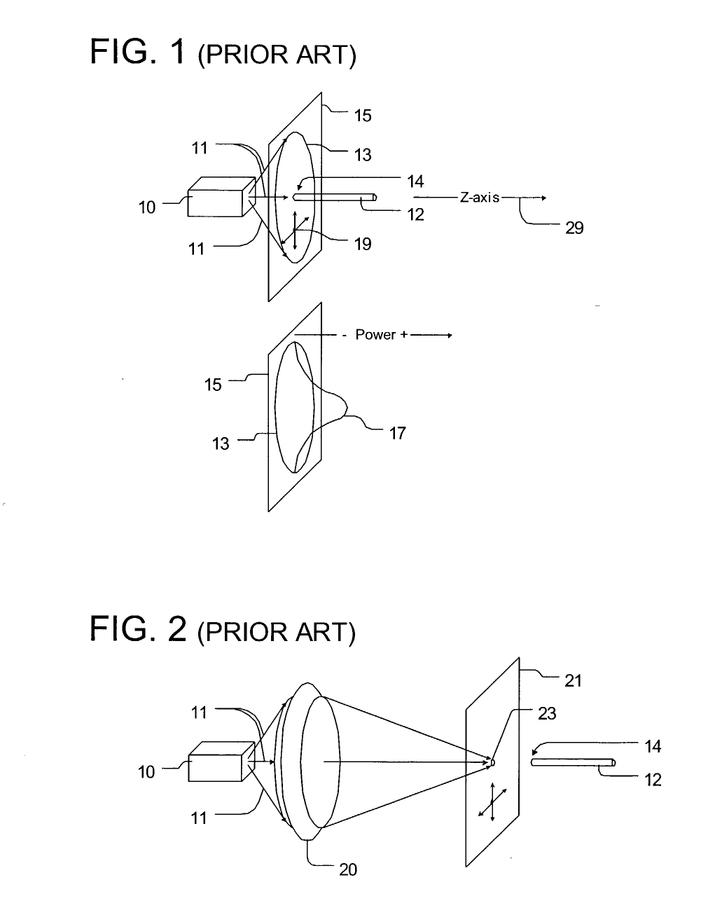

### DETAILED DESCRIPTION

As shown in the drawings for purposes of illustration, the present invention is embodied in an apparatus including an optical source adapted to provide optical signal and a beam shaping lens system adapted to converge the optical signal into a predetermined shape at a focal plane. A receiving end of a waveguide is placed within the area of the predetermined shape at the focal plane. The predetermined shape is sized and designed such that lateral misalignments of the waveguide within the area of the predetermined shape have relatively minor effect on the power transfer efficiency of the system.

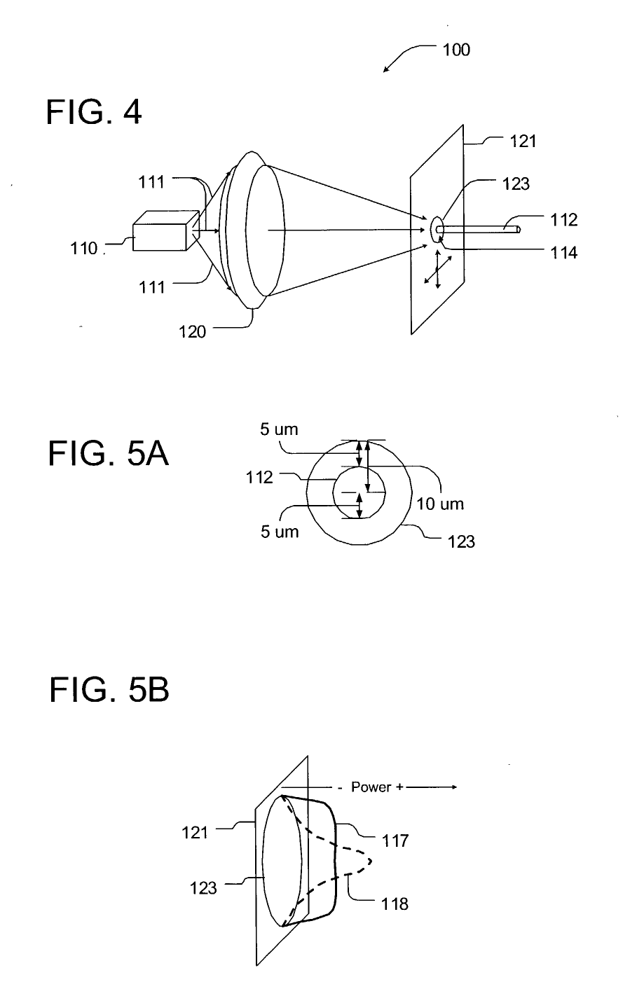

FIG. 4 illustrates an optical signal coupling system 100 according to one embodiment of the present invention. The system 100 includes an optical source 110. The source 110 can be a laser or a waveguide such as optical fiber. For convenience, the optical source 110 is illustrated as a laser. The laser 110 provides optical signal (represented by vectors 111) that diverges upon leaving the laser 110. Vectors 111 and other vectors used to illustrate directions of light, or optical signals, are only used for clarity of discussion and are not intended to represent ray traces as is commonly used in the art of optics.

A beam shaping lens system 120 converges the optical signal 111 into a focal area 123 at a focal plane 121. A waveguide such as optical fiber 112 receives the converged optical signal. The optical fiber 112 has a receiving end 114 at the focal plane 121 within the focal area 123. The converged optical signal at the focal area 123 has a predetermined power distribution profile such as a uniform distribution, illustrated in FIG. 5B. FIG. 5B illustrates a sample power distribution profile curve 117. In the illustrated embodiment, at the focal area 123, the converged optical signal has a power distribution that is generally uniform within the focal area. In other embodiments, the power distribution can vary within the focal area 123. For example, the optical signal can be converged with the edges having more power than the center.

The beam shaping lens system 120 is designed such as to produce the focal area 123 that is larger than the cross sectional area of the waveguide 112 on the focal plane 121, the converged light having, for example, a uniform power distribution. Consequently, the waveguide will only receive a portion of the power of the optical signal 111 converging at the focal area 123; however, lateral misalignments of the waveguide 112 has relatively little effect on the amount of the power received by the waveguide 112, assuming that the misaligned waveguide 112 lies within the focal area 123. Therefore, the optical signal coupling system 100 is less sensitive to misalignments of the waveguide 112 than the butt coupled system or the lens coupled system.

Alternatively, the beam shaping lens system 120 can be designed to produce the focal area 123 that is larger than the cross sectional area of the waveguide 112 on the focal plane 121 while retaining the Gaussian-like power distribution of the optical signal 111. The Gaussian-like power distribution is illustrated as a Gaussian-like power distribution curve 118 of FIG. 5B. Such distribution can be produced by defocusing the optical signal 111 onto the focal plane 121. Here again, because the focal area 123 is larger than the cross sectional area of the waveguide 112, lateral misalignments of the waveguide 112 has relatively little effect on the amount of the power received by the waveguide 112, assuming that the misaligned waveguide 112 lies within the focal area 123. Therefore, the optical signal coupling system 100 is less sensitive to misalignments of the waveguide 112 than the butt coupled system or the lens coupled system. While the defocused optical signal technique can be used to improve power transfer efficiency and misalignment tolerances, the beam-shaping lens technique that result in a predetermined power output profile (such as the sample power distribution profile curve 117 of FIG. 5B) is preferred.

On one hand, the tolerance to the misalignments can be adjusted by adjusting the size of the focal area 123. For example, if the optical signal coupling system 100 is to be produced to tolerate five microns of misalignment in positive or negative direction in X-axis or in Y-axis, then the beam shaping lens system 120 can be designed to produce a focal area 123 having a radius of five microns larger than the radius of the cross section of the waveguide 112. This is illustrated in FIG. 5A. Referring to FIG. 5A, the focal area 123 and the cross section of the waveguide 112 is illustrated. For example, the waveguide 112 is an optical fiber having a core cross-section radius of five microns. For five micron tolerance (in all lateral directions) the focal area 123 is designed to have a ten micron radius. On the other hand, the coupling efficiency decreases as the size of the focal area 123 is increased. This is because larger focal area 123 requires the power of the optical signal to be spread out, thereby having less optical power per square unit of area. Consequently, the cost of increasing misalignment tolerance is the reduction in the coupling efficiency. In fact, the illustrated elliptical focal area 123 can be produced as a uniform elliptical or circular focal area defined by the converged optical signal.

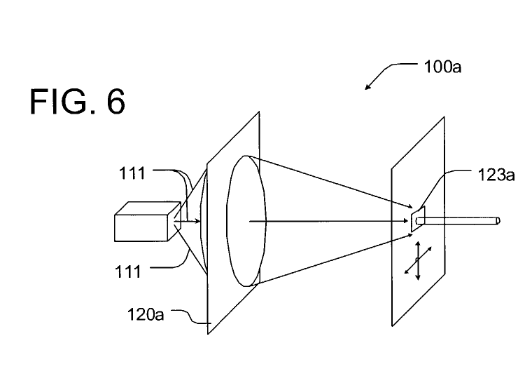

The beam shaping lens system 120 can include one or more optical components including reflective optics, refractive optics, diffractive optics, or any combination of these. In one embodiment, the beam shaping lens system 120 is a diffractive lens designed to converge the optical signal 111 to the focal area 123 on the focal plane 121. For example, the focal area 123 can have radius ranging from 10 to 20 microns, and can be other shapes such as a rectangular or elliptical shape. Further, as already discussed, the power distribution, or irradiance, of the converted light can vary. In one possible embodiment, the power distribution is uniform throughout the focal area. A rectangular focal area is illustrated in FIG. 6.

FIG. 6 illustrates another embodiment of the present invention having a certain alternate configuration. Portions of the alternate embodiment are similar to those shown in FIG. 4. For convenience, portions in FIG. 6 that are similar to portions in FIG. 4 are assigned the same reference numerals, analogous but changed components are assigned the same reference numerals accompanied by letter “a”, and different components are assigned different reference numerals. FIG. 6 illustrates an optical signal coupling system 100a according to another embodiment of the present invention. Here, the beam shaping lens system 120a converges the optical signal 111 into a rectangular focal area 123a. The rectangular focal area 123a can be a square having sides with lengths ranging from 20 to 30 microns. Again, the optical signal can be converged within the rectangular focal area 123a having a predetermined power distribution, for example, uniform power distribution.

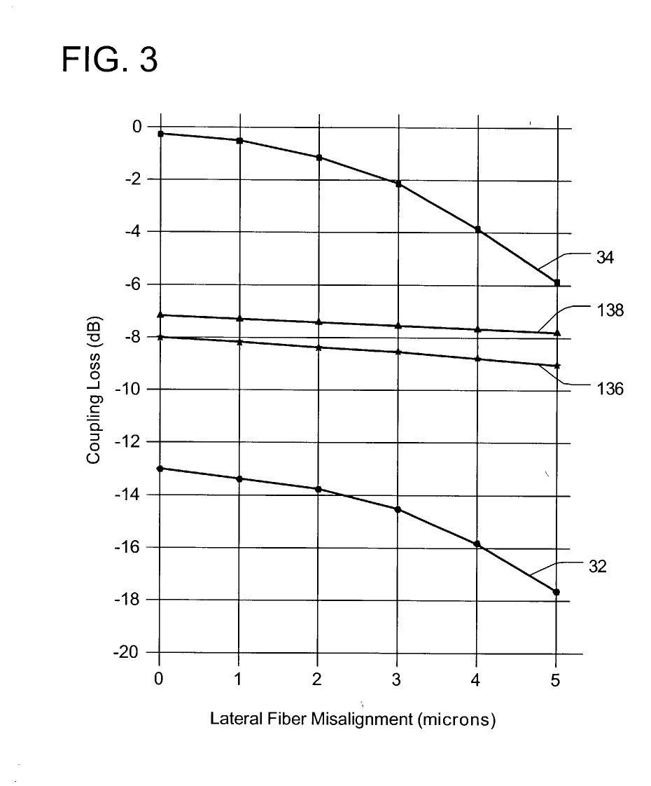

The coupling efficiency of the optical signal coupling system 100 and 100a are illustrated in FIG. 3. Referring to FIG. 3, for the optical signal coupling system 100 of FIG. 4, a defocused circular focal area curve 136 shows, for comparison, that the coupling efficiency varies from approximately −8 dB loss to approximately −9 dB loss for lateral misalignments ranging from zero to five microns. For the optical signal coupling system 100a of FIG. 6, a uniformly irradiated square focal area curve 138 shows that the coupling efficiency varies from approximately −7.1 dB loss to approximately −7.7 dB loss for lateral misalignments ranging from zero to five microns. Both of these implementations are much less sensitive to lateral misalignments compared to the butt coupling system (efficiency of which is illustrated using the butt coupling system efficiency curve 32) or the lens coupling system (efficiency of which is illustrated using the lens coupling system efficiency curve 34). However, in general, use of focal areas having uniform power distribution (such as the sample power distribution profile 117 of FIG. 5B) results in better coupling efficiency and improved tolerance to misalignments.

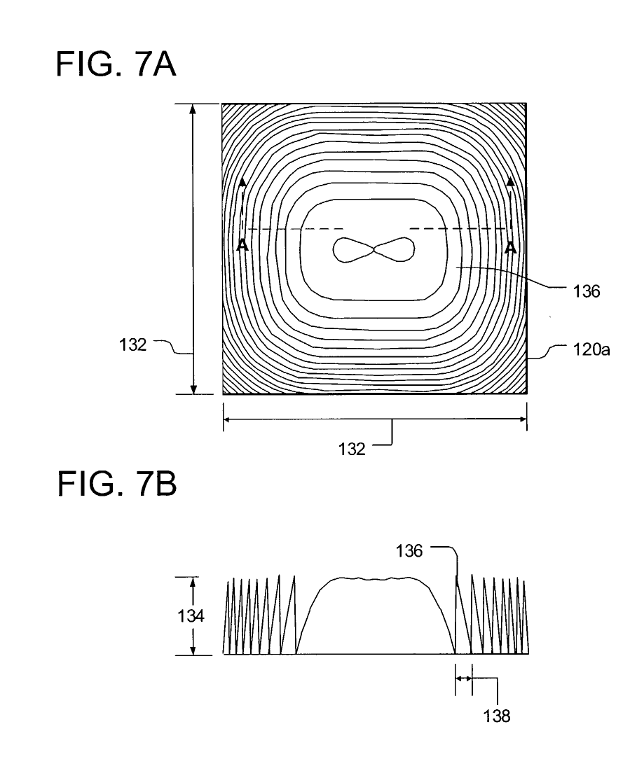

The beam shaping lens systems 120 and 120a of FIGS. 4 and 6, respectively, can be implemented using one or multiple optical elements each having reflective, refractive, or diffractive properties. One embodiment of the beam shaping lens system 120a is illustrated in FIG. 7A as a diffractive optical element (DOE) 120a. In FIG. 6, the beam shaping lens system 120a is shown in a perspective view mostly from a side of the optical signal coupling system 100a. FIG. 7A illustrates a front view of one embodiment of the diffractive optical element 120a of FIG. 6. FIG. 7B illustrates a cut-away side view of a portion of the diffractive optical element 120a along line A-A of FIG. 7A. Referring to FIGS. 7A and 7B, in the illustrated embodiment, the optical beam shaping lens system 120a is a rectangular diffractive lens 120a having sides with lengths 132 of approximately 250 micrometers (um). To converge the optical signal 111 of FIG. 6, the rectangular diffractive lens 120a has a series of concentric grooves with varying grating period. In the illustrated embodiment, the groove profiles can have height 134 of, for example, 0.5 um and widths ranging from 25 um near the center to 0.50 um near the edge. For example, the sample grating period 136 has a width 138 of 12 um.

From the foregoing, it will be appreciated that the present invention is novel and offers advantages over the current art. Although a specific embodiment of the invention is described and illustrated above, the invention is not to be limited to the specific forms or arrangements of parts so described and illustrated. The invention is limited by the claims that follow. In the following, claims drafted to take advantage of the “means or steps for” provision of 35 USC section 112 are identified by the phrase “means for.”

What is claimed is:

1. An apparatus comprising:
an optical source adapted to provide optical signal;
a beam shaping lens system adapted to converge the optical signal into a focal area at a focal plane, the converged optical signal having a predetermined power distribution profile at the focal area; and
a waveguide with a core adapted to receive said converged optical signal within said focal area at said focal plane, said focal area defining an area greater than the cross sectional area of the core.

2. The apparatus recited in claim 1 wherein the predetermined power distribution profile is a uniform distribution.

3. The apparatus recited in claim 2 wherein the focal area is circular in shape.

4. The apparatus recited in claim 3 wherein the focal area defines an area having a diameter ranging from 20 to 30 microns.

5. The apparatus recited in claim 2 wherein the focal area has rectangular shape.

6. The apparatus recited in claim 5 wherein the rectangular focal area has sides having lengths ranging from 20 to 30 microns.

7. The apparatus recited in claim 1 wherein the focal area has elliptical shape.

8. The apparatus recited in claim 1 wherein said beam shaping lens system comprises a diffractive lens.

9. The apparatus recited in claim 1 wherein said beam shaping lens system comprises a refractive lens.

10. The apparatus recited in claim 1 wherein said optical source is a laser.

11. The apparatus recited in claim 1 wherein said waveguide is a single mode optical fiber.

12. An apparatus comprising:
a laser adapted to provide optical signal;
a diffractive optical element adapted to converge the optical signal into a circular focal area at a focal plane, the optical signal having a predetermined power distribution profile at the focal area; and
a waveguide fiber with core adapted to receive the converged optical signal, said focal area being larger than the cross sectional area of the core of the waveguide.

13. The apparatus recited in claim 12 wherein said circular focal area has a uniform power distribution.

14. A method of coupling optical signal, said method comprising:
converging the optical signal into a focal area at a focal plane, the converged optical signal having a predetermined power distribution profile at the focal area; and
receiving the converged optical signal into a waveguide, said focal area defining an area greater than the cross sectional area of the waveguide core.

15. The method recited in claim 14 wherein a beam shaping lens system converges the optical signal.

16. The method recited in claim 15 wherein said beam shaping lens system comprises a diffractive lens.

17. The method recited in claim 15 wherein said beam shaping lens system comprises a refractive lens.

18. The method recited in claim 14 wherein said focal area defines a circular area having a uniform power distribution.

19. The method recited in claim 14 wherein said focal area has a rectangular shape having a uniform power distribution.

20. The method recited in claim 14 wherein said focal area has elliptical shape.
